(19) United States
(12) Patent Application Publication
(10) Pub. No.: US 2016/0364792 A1
(43) Pub. Date: Dec. 15, 2016

(54) CLOUD SERVICE BROKERAGE METHOD AND APPARATUS USING SERVICE IMAGE STORE

(71) Applicant: Electronics and Telecommunications Research Institute, Daejeon (KR)

(72) Inventors: Dong-Jae KANG, Daejeon (KR); Won-Young KIM, Daejeon (KR); Jin-Mee KIM, Daejeon (KR); Hyun-Joo BAE, Daejeon (KR); Seok-Ho SON, Daejeon (KR); Ji-Hyun LEE, Daejeon (KR)

(21) Appl. No.: 15/010,420

(22) Filed: Jan. 29, 2016

(30) Foreign Application Priority Data
Jun. 15, 2015 (KR) 10-2015-0084496

(51) Int. Cl. G06Q 30/06

(52) U.S. Cl. CPC G06Q 30/0643

(57) ABSTRACT

Disclosed herein are a cloud service brokerage method and apparatus using a service image store. The cloud service brokerage apparatus includes a reception unit for receiving service requirements from each of users, a service image recommendation unit for recommending one or more candidate service images that satisfy the requirements among multiple service images stored in a service image store, a cloud server recommendation unit for recommending one or more candidate cloud servers that satisfy the requirements among multiple cloud servers, a registration unit for registering an optimal service image selected by the user from among the one or more candidate service images in an optimal cloud server selected by the user from among the one or more candidate cloud servers, and a transmission unit for transmitting results of a service implemented by executing the optimal service image on the optimal cloud server to the user.

### CROSS REFERENCE TO RELATED APPLICATION

This application claims the benefit of Korean Patent Application No. 10-2015-0084496, filed Jun. 15, 2015, which is hereby incorporated by reference in its entirety into this application.

### BACKGROUND OF THE INVENTION

1. Technical Field

The present invention generally relates to cloud service brokerage technology and, more particularly, to cloud service brokerage technology using a service image store, which can promptly provide various cloud services to users using a service image store.

2. Description of the Related Art

Recently, as the construction of cloud data centers has increased and the advent of various cloud-based application services has accelerated, there is a need for the deployment and management of multi-cloud services. Further, such a need supports the popularization of a cloud service brokerage platform.

User requirements for application services in a cloud environment have become diversified, but it is not easy to provide various application services or search for optimal application services suitable for requirements. Further, difficulty in setting up application services, an increase in the time required for service deployment, differences between usage environments of heterogeneous clouds, etc. cause the deterioration of the usage rate of cloud services.

Therefore, a new environment is required which can more easily access cloud-based various application services and in which application services can be continuously extended. Also, new cloud service brokerage technology is urgently required in which the complicated configuration setup of services and a service deployment procedure are simplified and then services that are desired to be used can be promptly deployed.

In connection with this, Korean Patent Application Publication No. 2011-0069732 (Date of Publication: Jun. 23, 2011) discloses a technology related to “Cloud Federation As a Service.”

### SUMMARY OF THE INVENTION

Accordingly, the present invention has been made keeping in mind the above problems occurring in the prior art, and an object of the present invention is to provide various cloud services that satisfy user requirements by mediating a plurality of heterogeneous cloud services that are geographically dispersed.

Another object of the present invention is to support the prompt deployment of services using a service image store.

A further object of the present invention is to enable open cloud service markets to be activated by removing the complexity of service configuration and setup and supporting the virtuous cycle structure of registration, selling, sharing, and acquisition of service images.

In accordance with an aspect of the present invention to accomplish the above objects, there is provided a cloud service brokerage apparatus using a service image store, including a reception unit for receiving service requirements from a user; a service image recommendation unit for recommending one or more candidate service images that satisfy the requirements among multiple service images stored in a service image store; a cloud server recommendation unit for recommending one or more candidate cloud servers that satisfy the requirements among multiple cloud servers; a registration unit for registering an optimal service image selected by the user from among the one or more candidate service images in an optimal cloud server selected by the user from among the one or more candidate cloud servers; and a transmission unit for transmitting results of a service implemented by executing the optimal service image on the optimal cloud server to the user.

The service image recommendation unit may recommend the one or more candidate service images using image metadata that includes at least one of basic image information, image execution environment information, and store operation information corresponding to the multiple service images.

The service image store may be configured to store the multiple service images so that each of the service images is classified as one of a public image accessible by other users and a private image accessible by only the user, based on ownerships included in the store operation information.

The service image recommendation unit may recommend the one or more candidate service images based on at least one of a cloud type, service specification, a service type, a price and a location that satisfy the requirements.

The cloud server recommendation unit may recommend the one or more candidate cloud servers based on the image execution environment information corresponding to the one or more candidate service images.

The service image recommendation unit may be configured to, when each of the one or more candidate service images corresponds to the public image, determine whether the candidate service image is a charged image, a price of which is fixed, and provide purchase information to the user.

The cloud service brokerage apparatus may further include service image acquisition unit for, when the user acquires the public image from the service image store, generating a new private image identical to the public image, copying image metadata corresponding to the public image, and generating new image metadata corresponding to the new private image.

The service image acquisition unit may check store operation information of the public image and generate no new private image when the public image is in use.

The cloud service brokerage apparatus may further include a service image sharing unit for, when the user shares the private image, generating a new public image identical to the private image, copying image metadata corresponding to the private image, and generating new image metadata corresponding to the new public image.

The service image sharing unit may be configured to, when the new public image is shared at a charge, record price information in the new image metadata, and set the new public image as a charged image.

In accordance with another aspect of the present invention to accomplish the above objects, there is provided a cloud service brokerage method using a service image store, including receiving service requirements from a user; recommending one or more candidate service images that satisfy the requirements among multiple service images stored in a service image store; recommending one or more candidate cloud servers that satisfy the requirements among multiple cloud servers; and transmitting, to the user, results of a service implemented by registering and executing an optimal service image selected by the user from among the one or more candidate service images on an optimal cloud server selected by the user from among the one or more candidate cloud servers.

Recommending the one or more candidate service images may be configured to recommend the one or more candidate service images using image metadata that includes at least one of basic image information, image execution environment information, and store operation information corresponding to the multiple service images.

The service image store may be configured to store the multiple service images so that each of the service images is classified as one of a public image accessible by other users and a private image accessible by only the user, based on ownerships included in the store operation information.

Recommending the one or more candidate service images may be configured to recommend the one or more candidate service images based on at least one of a cloud type, service specification, a service type, a price and a location that satisfy the requirements.

Recommending the one or more candidate cloud servers may be configured to recommend the one or more candidate cloud servers based on the image execution environment information corresponding to the one or more candidate service images.

Recommending the one or more candidate service images may include, when each of the one or more candidate service images corresponds to the public image, determining whether the candidate service image is a charged image, a price of which is fixed, if it is determined that the candidate service image is the charged image, purchase information is provided to the user.

The cloud service brokerage method may further include when the user acquires the public image from the service image store, generating a new private image identical to the public image, copying image metadata corresponding to the public image, and generating new image metadata corresponding to the new private image.

Generating the new private image may be configured to check store operation information of the public image and generate no new private image when the public image is in use.

The cloud service brokerage method may further include, when the user shares the private image, generating a new public image identical to the private image, copying image metadata corresponding to the private image, and generating new image metadata corresponding to the new public image.

Generating the new image metadata may be configured to, when the new public image is shared at a charge, record price information in the new image metadata, and set the new public image as a charged image.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a cloud service brokerage system using a service image store according to an embodiment of the present invention;

FIG. 2 is a block diagram showing an example of the cloud service brokerage apparatus shown in FIG. 1;

FIG. 3 is a block diagram showing in detail a cloud service brokerage system using a service image store according to an embodiment of the present invention;

FIG. 4 is a diagram showing an agent for registering a service image in a service image store according to an embodiment of the present invention;

FIG. 5 is a diagram showing a method for managing an image in the service image store according to an embodiment of the present invention;

FIG. 6 is an operation flowchart showing a cloud service brokerage method using a service image store according to an embodiment of the present invention;

FIG. 7 is an operation flowchart showing a method for removing a service image from a service image store according to an embodiment of the present invention;

FIG. 8 is an operation flowchart showing a method for sharing a private image according to an embodiment of the present invention; and

FIG. 9 is an operation flowchart showing a method for purchasing a public image from a service image store according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

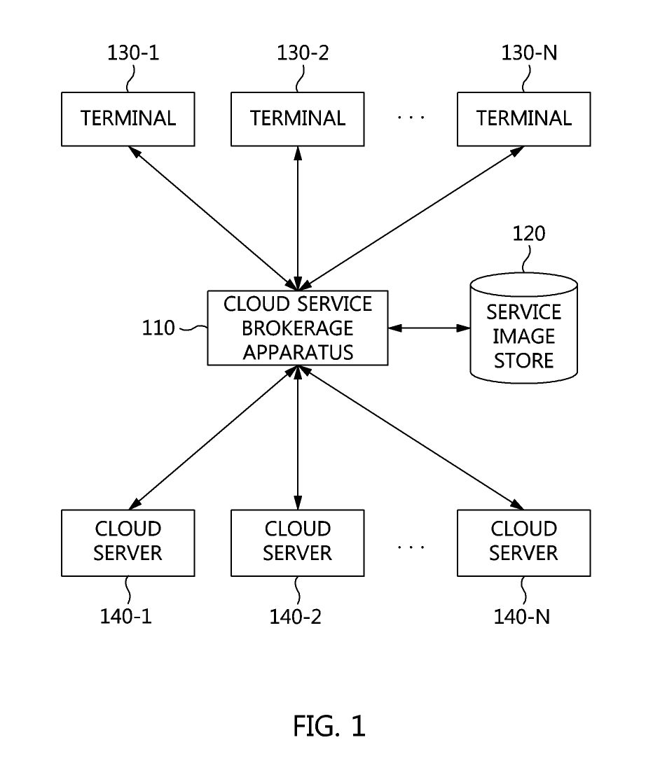

FIG. 1 is a block diagram showing a cloud service brokerage system using a service image store according to an embodiment of the present invention.

Referring to FIG. 1, a cloud service brokerage system using a service image store according to an embodiment of the present invention may include a cloud service brokerage apparatus 110, a service image store 120, user terminals 130-1 to 130-N, and cloud servers 140-1 to 140-N.

The cloud service brokerage apparatus 110 receives service requirements from the user terminals 130-1 to 130-N.

Further, the cloud service brokerage apparatus 110 recommends one or more candidate service images corresponding to the requirements among the multiple service images stored in the service image store 120.

Here, the one or more candidate service images may be recommended using image metadata including at least one of basic image information, image execution environment information, and store operation information which correspond to multiple service images.

The service image store 120 may store multiple service images so that each of the service images is classified as a public image that is accessible by other users and a private image that is accessible by only a designated user, based on ownerships included in the store operation information.

The one or more candidate service images may be recommended based on at least one of a cloud type, service specification, a service type, price, and location that satisfy requirements.

When each of the one or more candidate service images corresponds to a public image, whether the corresponding candidate service image is a charged image, the price of which is fixed, may be determined, and then purchase information may be provided to the user.

Further, the cloud service brokerage apparatus 110 recommends one or more candidate cloud servers that satisfy the requirements among the multiple cloud servers 140-1 to 140-N.

Here, the one or more candidate cloud servers may be recommended based on image execution environment information corresponding to the one or more candidate service images.

The cloud service brokerage apparatus 110 registers an optimal service image selected by the user from among the one or more candidate service images in an optimal cloud server selected by the user from among the one or more candidate cloud servers.

The cloud service brokerage apparatus 110 transmits the results of a service implemented by executing the optimal service image on the optimal cloud server to the user terminals 130-1 to 130-N.

Further, when the user acquires a public image from the service image store 120, the cloud service brokerage apparatus 110 generates a new private image identical to the public image, copies image metadata corresponding to the public image, and generates new image metadata corresponding to the new private image.

Here, the store operation information of the public image is checked, and a new private image may not be generated when the public image is in use.

Further, when the user shares a private image with others, the cloud service brokerage apparatus 110 generates a new public image identical to the private image, copies image metadata corresponding to the private image, and generates new image metadata corresponding to the new public image.

Here, when the new public image is shared at a charge, price information is recorded in new image metadata, and the new public image may be set as a charged image.

The purpose of the service image store 120 may be to register, share, and manage various service images.

Here, the term “service image” may denote the form of a file generated such that, after target application software has been installed and configuration setup thereof has been completed, it has been arranged in a cloud server and can be immediately executed, in order for the user to promptly use a specific application service such as a web server, a collaboration tool, office software, and Enterprise Risk Management (ERM). That is, such a service image may correspond to a virtual machine image, for which software required by a virtual machine is installed and configuration setup thereof has been completed.

The terminals 130-1 to 130-N may correspond to devices by which users receive the service results from the cloud servers 140-1 to 140-N through the cloud service brokerage apparatus 110.

The users of the terminals 130-1 to 130-N may be companies or individuals that desire to use the cloud service provided by the cloud service brokerage apparatus 110, for example, application service providers or normal users for providing a virtual system-based application service.

Further, the terminals 130-1 to 130-N are devices that are individually connected to a communication network and are capable of receiving the service results based on the cloud service brokerage system. Such a terminal is not limited to a mobile communication terminal, but may be any of various types of terminals, such as all information communication devices, multimedia terminals, wired terminals, fixed terminals, and Internet Protocol (IP) terminals. Further, each of the terminals 130-1 to 130-N may be any of mobile terminals having various mobile communication specifications, such as a mobile phone, a Portable Multimedia Player (PMP), a Mobile Internet Device (MID), a smart phone, a desktop computer, a tablet Personal Computer (PC), a notebook computer, a netbook computer, a Personal Digital Assistant (PDA), a smart TV, and an information communication device.

The cloud servers 140-1 to 140-N may be service infrastructures of cloud service providers that desire to provide services to users through the cloud service brokerage apparatus 110. Infrastructure As a Service (IaaS), on which virtual machines can be driven, may be the most general instance of service infrastructures. Therefore, the cloud servers 140-1 to 140-N may be servers registered in the cloud service brokerage apparatus 110. For example, multiple heterogeneous cloud service providers may register services in the cloud service brokerage apparatus 110, and provide the registered services to the user terminals 130-1 to 130-N together with additional services.

Therefore, from the standpoint of cloud service providers, the cloud service brokerage apparatus 110 may function as an open market for selling services, and from the standpoint of cloud service users, the cloud service brokerage apparatus 110 may provide convenience so that various cloud services may be searched for, selected, deployed, and managed. That is, the cloud service brokerage apparatus 110 may mediate the cloud service between the users and the providers, thus enabling an open cloud service market to be provided.

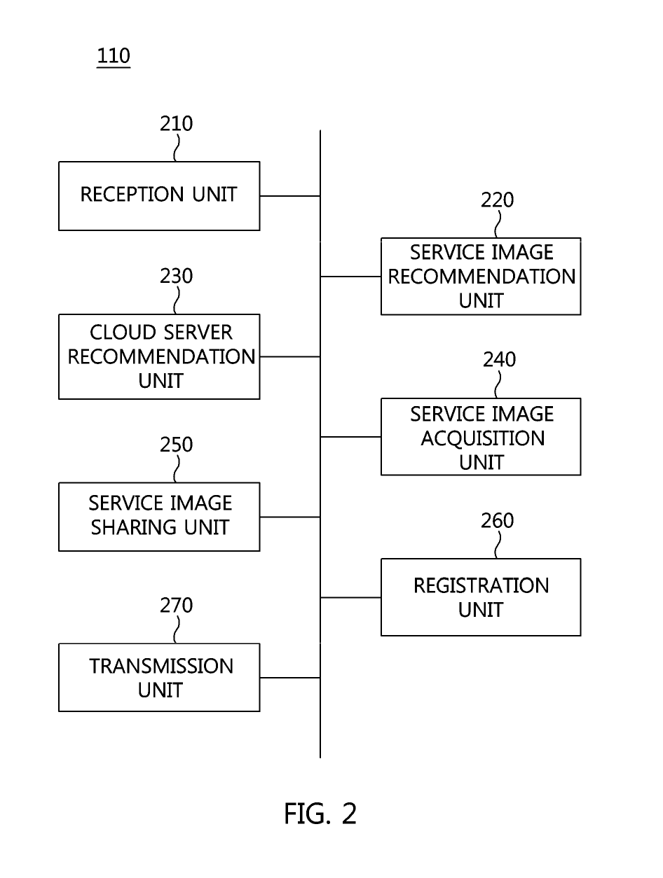

FIG. 2 is a block diagram showing an example of the cloud service brokerage apparatus shown in FIG. 1.

Referring to FIG. 2, the cloud service brokerage apparatus 110 shown in FIG. 1 may include a reception unit 210, a service image recommendation unit 220, a cloud server recommendation unit 230, a service image acquisition unit 240, a service image sharing unit 250, a registration unit 260, and a transmission unit 270.

The reception unit 210 receives service requirements from users. For example, when users, such as companies or individuals desiring to use a cloud service, input requirements for desired services using terminals, the reception unit 210 may receive the requirements input by the users over a communication network.

Here, the received requirements may include information such as the type of cloud server, the specification of service, the type of service, a purchase price, and a location.

The service image recommendation unit 220 recommends one or more candidate service images corresponding to the requirements among multiple service images stored in a service image store.

Here, the service image store may manage various types of service images to provide various services to each user. Therefore, candidate service images suitable for the requirements requested by the user may be recommended among various service images stored in the service image store. Further, as the candidate service images, several images may be recommend depending on the requirements requested by the user.

Here, the term “service image” may denote the form of a file generated such that, after target application software has been installed and configuration setup thereof has been completed, it has been arranged in a cloud server and can be immediately executed, in order for the user to promptly use a specific application service such as a web server, a collaboration tool, office software, and Enterprise Risk Management (ERM). That is, such a service image may correspond to a virtual machine image, for which software required by a virtual machine is installed and configuration setup thereof has been completed.

The one or more candidate service images may be recommended using image metadata including at least one of basic image information, image execution environment information, and store operation information which correspond to multiple service images. That is, the image metadata may be a part having various types of additional information including the identifiers of respective service images stored in the service image store, and may be located inside or outside of the cloud service brokerage apparatus.

Therefore, the one or more candidate service images may be searched for using the image metadata without accessing the service image store in which actual images are stored.

The basic image information may be a part describing each service image's own information, the image execution environment information may be information required so as to arrange and run the service images in cloud servers, and the store operation information may be information required so as to maintain and manage the service image store. For example, the basic image information may include information such as the name and identifier of each image, the access location of each image in the service image store, service configuration and setup information included in each image, and the price of each image. Further, the image execution environment information may include information such as the execution environment of each image, resource specification, the type of execution hypervisor, and a suitable cloud type. Finally, the store operation information may include information about ownerships enabling users capable of accessing the corresponding images to be limited, and values indicating whether the corresponding images are in use. When the ownership of a service image corresponds to a public image, all users can access the image, whereas when the ownership of a service image corresponds to a private image, only a user who registered the service image may access the image. Further, the case where an image is in use may correspond to the procedure for processing of the purchase or acquisition of the image, the procedure for sharing or selling the image, or the procedure for deleting the image.

Therefore, metadata that may include all of the above-described information may have the form of a database (DB).

Here, the service image store may store multiple service images so that each of the images is classified as one of a public image accessible by other users and a private image accessible by only a designated user, based on the ownerships included in the store operation information.

Further, the service image store, which is a place in which service images are actually stored, may be divided into a public image storage in which public images are stored and a private image storage in which private images are stored. Furthermore, in the private image storage, users' image storage spaces divided for respective users may be provided.

That is, public images are service images accessible by all users, and may be stored in the public image storage. Further, such public images may be either free images or charged images, the specific prices of which are fixed, depending on the intensions of users who register the images. Furthermore, private images are service images accessible by only users who registered the service images, and may be stored only in the private image storages of corresponding registrants.

Therefore, when each user searches for a service image, a search target may correspond to all service images stored in the public image storage and service images stored in the private image storage of the user who performs a search. Here, values used to search for images may be designated based on the values of basic image information and image execution environment information. For example, the case where a web server service image, which is executed on an OpenStack cloud server and supports a load balancer, and the price of which is below 300 dollars, is searched for may correspond to such a search case.

Here, one or more candidate service images may be recommended based on at least one of a cloud type, service specification, a service type, price, and location that satisfy requirements. For example, candidate service images may be searched for and recommended based on pieces of information corresponding to items related to the selection of candidate service images among pieces of information included in the requirements.

When at least one candidate service image corresponds to a public image, it is determined whether the candidate service image is a charged image, the price of which is fixed, and then purchase information may be provided to the user. For example, when a recommended candidate service image is assumed to be a charged image, a payment button enabling a payment flow to be performed may be provided together with the price of the corresponding charged image.

The cloud server recommendation unit 230 recommends one or more candidate cloud servers that satisfy requirements among multiple cloud servers. That is, cloud servers capable of executing one or more candidate service images recommended based on the user's requirements may be recommended.

Here, one or more candidate cloud servers may be recommended based on image execution environment information corresponding to the one or more candidate service images. For example, the information of cloud servers suitable for the arrangement of the corresponding service image may be acquired based on the image execution environment information, and candidate cloud servers may be searched for and recommended using the acquired information.

The service image acquisition unit 240 is configured to, when the user acquires a public image from the service image store, generate a new private image identical to the public image, copy image metadata corresponding to the public image, and then generate new image metadata corresponding to the new private image.

Here, the storage operation information of the public image is checked, and a new private image may not be generated when the public image is in use.

For example, if it is assumed that service image A registered in the public image storage is acquired in order for the user to use service image A, it may be determined whether service image A is currently in use, using the image metadata of service image A. The image metadata of service image A is copied to generate new image metadata B only when service image A is not in use, and thereafter the value of image metadata B may be set to ‘in use’. Then, service image A may be copied to the image storage of the private user and then private image B may be generated. Further, after information corresponding to private image B has been registered in generated image metadata B, the values of service image A and private image B, set to ‘in use’, may be released.

When the user shares a private image, the service image sharing unit 250 generates a new public image identical to the private image, copies image metadata corresponding to the private image, and then generates new image metadata corresponding to the new public image.

Here, when the new public image is shared at a charge, price information is recorded in the new image metadata, and the new public image may be set as a charged image.

For example, assuming that a private user shares service image C registered in his or her private image storage with the public image storage, it may be determined whether service image C is currently in use, using the image metadata of service image C. The image metadata of service image C may be copied to generate new image metadata D only when service image C is not in use, and the value of image metadata D may be set to ‘in use’. Thereafter, service image C may be copied to the public image storage, and then public image D may be generated. After information corresponding to public image D has been recorded in generated image metadata D, the values of both service image C and public image D, set to ‘in use’, may be released.

The registration unit 260 registers an optimal service image selected by the user from among the one or more candidate service images in an optimal cloud server selected by the user from among the one or more candidate cloud servers.

Here, information about the one or more candidate cloud servers may be provided to the user so that the user may select the optimal cloud server. Further, information about the one or more candidate service images may be provided to the user so that the user may select the optimal service image.

The transmission unit 270 transmits the results of a service implemented by executing the optimal service image on the optimal cloud server to the user. That is, the service requested by the user is executed on the optimal cloud server via the optimal service image, and the results of execution are transmitted back to the user, thus mediating the cloud service.

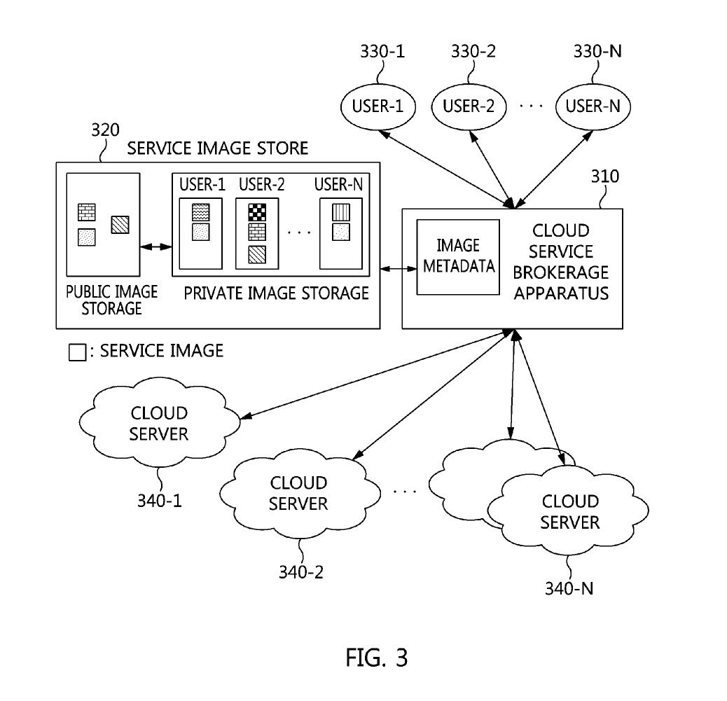

FIG. 3 is a block diagram showing in detail a cloud service brokerage system using a service image store according to an embodiment of the present invention.

Referring to FIG. 3, in the cloud service brokerage system using a service image store according to the embodiment of the present invention, each of users 330-1 to 330-N who use a cloud service brokerage apparatus 310 may be a company or an individual that desires to use a cloud service provided by the cloud service brokerage apparatus 310, for example, an application service provider or a normal user that provides a virtual system-based application service.

The cloud service brokerage apparatus 310 allows multiple heterogeneous cloud service providers to register services and may provide the corresponding service, together with additional services, to the users 330-1 to 330-N. That is, from the standpoint of cloud service providers, the cloud service brokerage apparatus 310 may function as an open market for selling services, and from the standpoint of cloud service users, the cloud service brokerage apparatus 310 may provide convenience so that various cloud services may be searched for, selected, deployed, and managed.

Here, image metadata is a part having various types of additional information including the identifiers of respective service images stored in a service image store 320, and may be located inside or outside of the cloud service brokerage apparatus 310.

The service image store 320, which is a place in which service images are actually stored, may be chiefly divided into a public image storage and a private image storage. In the private image storage, users' image storage spaces divided for respective users may be provided.

The cloud servers 340-1 to 340-N connected to the cloud service brokerage apparatus 310 are the service infrastructures of cloud service providers that desire to provide services to the users 330-1 to 330-N through the cloud service brokerage apparatus 310, and IaaS on which virtual machines may be driven may be the most general case of the service infrastructures.

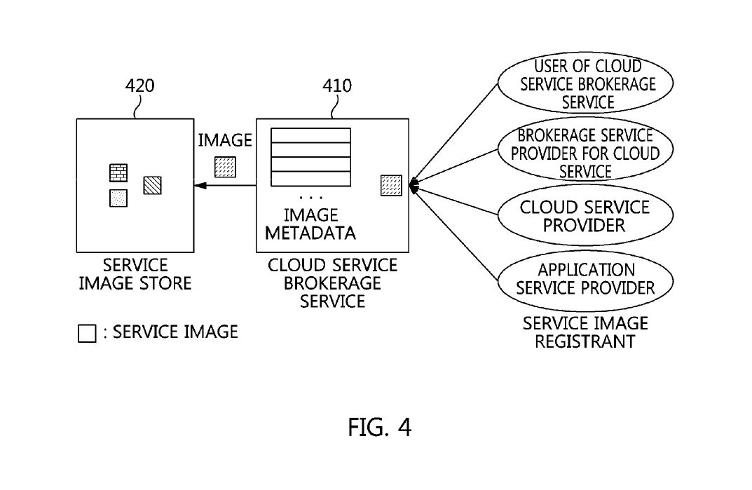

FIG. 4 is a diagram showing an agent for registering a service image in a service image store according to an embodiment of the present invention.

Referring to FIG. 4, an agent that registers a service image in a service image store 420 according to an embodiment of the present invention may be present in various forms such as the user of the cloud service brokerage apparatus, a brokerage service provider for a cloud service, a cloud service provider, and an application service provider.

In order for the agent that registers a service image to store, that is, register, a service image, the input of information for image metadata, together with a service image to be registered, may be required.

The image metadata may have the form of a file or a DB, and may be composed of pieces of information, such as basic image information, image execution environment information, and store operation information.

Here, the basic image information is a part describing each service image's own information and may include information corresponding to at least one of the name of each service image to be registered, the identifier of the image, access location in the service image store 420, service configuration and setup information included in the image, and the price of the image.

Further, the image execution environment information is a part describing information required so as to arrange and run each service image in the corresponding cloud server, and may include information corresponding to at least one of an execution environment such as resource specification, the type of execution hypervisor, and the type of cloud suitable for execution.

The store operation information is a part describing information required so as to maintain and manage the service image store, and may include information corresponding to at least one of the ownership of each image and the value of the image, such as ‘in use’ or ‘not in use’. Here, the ownership is intended to limit users capable of accessing the corresponding service image, wherein when a service image is public, the service image is accessible by all users, whereas when a service image is private, the service image is accessible by only a user who registered the corresponding service image. Further, the value of ‘in use’ or ‘not in use’ may correspond to a value set when the corresponding service image is being accessed by another user. For example, the value of ‘in use’ may indicate the case where the corresponding image is currently being used, as in the case where the user copies a public image to store the image in the private image storage during a procedure in which the user purchases the public image, or the case where a public image is being deleted.

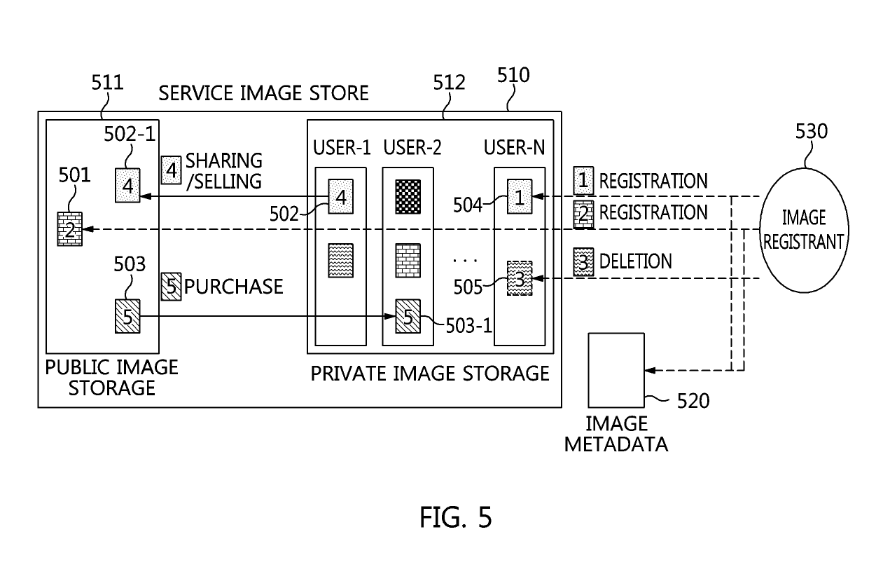

FIG. 5 is a diagram showing a method for managing an image in a service image store according to an embodiment of the present invention.

Referring to FIG. 5, an image registrant 530 according to an embodiment of the present invention may input image metadata, together with a service image that is desired to be registered in a service image store 510.

Here, images 501 and 504 to be registered may be registered so that they are separated and stored in a public image storage 511 and in a private image storage 512, respectively, depending on information about ownerships input to image metadata, as shown in FIG. 5.

Public images stored in the public image storage 511 may be service images that are accessible by all users who use the cloud service brokerage apparatus. Further, the public images may be free images or charged images, the specific prices of which are fixed, depending on the intentions of users who register the images.

Further, the private images stored in the private image storage 512 may be service images accessible by only each user who registers service images. Further, private images may be stored in the storage spaces of respective users who register the service images.

The deletion of service images may be performed in the same manner for private images and for public images.

Such a deletion procedure is described below by way of example. Whether an image 505 to be deleted is in use is determined from the image metadata of the image 505. When the image 505 to be deleted is in use, it cannot be deleted. In contrast, when the image 505 to be deleted is not in use, the value of image metadata of the image 505 to be deleted may be set to ‘in use’ so that the image 505 may be deleted. Thereafter, the image 505 is deleted from the service image store 510, and the image metadata of the deleted image 505 may also be deleted.

Further, a search for a service image is an operation which does not access the service image store 510 in which actual images are stored, and is configured to search for a desired service image, based on image metadata. For example, when the user searches for an image, a search may be performed in all public images stored in the public image storage and images stored in the private image storage of the user who performs a search.

Further, the values used to search for images may correspond to basic image information and image execution environment information included in the image metadata. For example, a web server service image, which is executed on an OpenStack cloud server and supports a load balancer, and the price of which is below 300 dollars, may be used as a condition value for a search.

Here, a request for sharing and selling service images may be supported via information about ownerships set when the service images are registered.

When a service image is registered, if the ownership thereof is set to ‘public use’, the corresponding service image is accessible by all users. When a service image is intended for sale, a suitable price may also be input together with the corresponding service image. Further, when a service image is intended to be shared free, it may be distributed as a free image.

Meanwhile, when a service image is registered, if the ownership information thereof is set to ‘private use’, a private user image may be changed to a public image by allowing the registrant of the service image to change the ownership information to ‘public use’. Here, the service image stored in the private image storage may be copied to the public image storage.

For example, the image metadata of an image 502, which is stored in the private image storage 512 and is to be shared, is checked, and then it may be determined whether the image 502 is in use. If it is determined that the image 502 is in use, it is impossible to currently share the image 502, whereas if it is determined that the image 502 is not in use, the value of image metadata of the image 502 to be shared may be set to ‘in use’ so that the image may be processed to be shared.

Thereafter, the image metadata of the image 502 to be shared may be copied to generate new image metadata for a shared image 502-1, and the value of the new image metadata may be set to ‘in use’.

Next, the image 502 stored in the private image storage 512 may be copied to the public image storage 511.

Then, the information of the shared image 502-1, copied to the public image storage 511, may be recorded in new image metadata, and the values of both the image 502 to be shared and the shared image 502-1, set to ‘in use’, may be released to ‘not in use’.

Further, a request for purchasing and acquiring a service image may correspond to the case where a private user purchases a service image registered in the public image storage or acquires the service image for free so as to use the service image.

For example, it may be determined whether a target image 503 that is desired to be purchased or acquired is in use by checking the image metadata of the target image 503. When it is determined that the target image 503 is in use, it is impossible to currently purchase or acquire the target image 503. In contrast, when it is determined that the target image 503 is not in use, the value of the image metadata of the target image 503 may be set to ‘in use’ so as to process the image 503 to be purchased or acquired.

Thereafter, the image metadata of the target image 503 is copied to generate new image metadata for a purchased image 503-1, and the value of the new image metadata may be set to ‘in use’.

Then, the target image 503 stored in the public image storage 511 may be copied to the private image storage 512 of the user who requested the purchase or acquisition of the image 503.

Thereafter, the information of the purchased image 503-1, copied to the private image storage 512, is recorded in the new image metadata, and the values of both the target image 503 and the purchased image 503-1, set to ‘in use’, may be released to ‘not in use’.

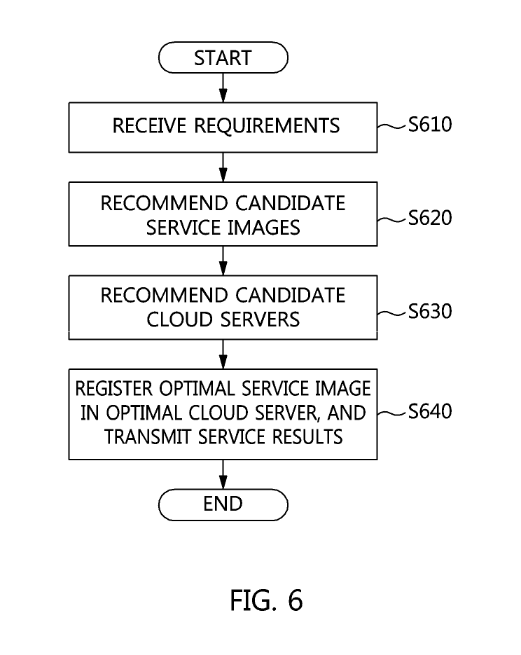

FIG. 6 is an operation flowchart showing a cloud service brokerage method using a service image store according to an embodiment of the present invention.

Referring to FIG. 6, the cloud service brokerage method using a service image store according to the embodiment of the present invention receives service requirements from users at step S610. For example, when users, such as companies or individuals that desire to use a cloud service, input requirements for a desired service using terminals, the requirements input by the users may be received over a communication network.

Here, the received requirements may include information such as the type of cloud server, the specification of service, the type of service, a purchase price, and a location.

Further, the cloud service brokerage method using a service image store according to the embodiment of the present invention recommends one or more candidate service images that satisfy the requirements among multiple service images stored in the service image store at step S620.

In this case, the service image store may manage various types of service images to provide various services to each user. Therefore, candidate service images suitable for the requirements requested by the user may be recommended among various service images stored in the service image store. Further, as the candidate service images, several images may be recommend depending on the requirements requested by the user.

Here, “service image” may denote the form of a file generated such that, after target application software has been installed and configuration setup thereof has been completed, it has been arranged in a cloud server and can be immediately executed, in order for the user to promptly use a specific application service such as a web server, a collaboration tool, office software, and ERM. That is, such a service image may correspond to a virtual machine image, for which software required by a virtual machine is installed and configuration setup thereof has been completed.

The one or more candidate service images may be recommended using image metadata including at least one of basic image information, image execution environment information, and store operation information which correspond to multiple service images. That is, the image metadata may be a part having various types of additional information including the identifiers of respective service images stored in the service image store, and may be located inside or outside of the cloud service brokerage apparatus.

Therefore, the one or more candidate service images may be searched for using the image metadata without accessing the service image store in which actual images are stored.

The basic image information may be a part describing each service image's own information, the image execution environment information may be information required so as to arrange and run the service images in cloud servers, and the store operation information may be information required so as to maintain and manage the service image store. For example, the basic image information may include information such as the name and identifier of each image, the access location of each image in the service image store, service configuration and setup information included in each image, and the price of each image. Further, the image execution environment information may include information such as the execution environment of each image, resource specification, the type of execution hypervisor, and a suitable cloud type. Finally, the store operation information may include information about ownerships enabling users capable of accessing the corresponding images to be limited, and values indicating whether the corresponding images are in use. When the ownership of a service image corresponds to a public image, all users can access the image, whereas when the ownership of a service image corresponds to a private image, only a user who registered the service image may access the image. Further, the case where an image is in use may correspond to the procedure for processing of the purchase or acquisition of the image, the procedure for sharing or selling the image, or the procedure for deleting the image.

Therefore, metadata that may include all of the above-described information may have the form of a DB.

Here, the service image store may store multiple service images so that each of the images is classified as one of a public image accessible by other users and a private image accessible by only a designated user, based on the ownerships included in the store operation information.

Further, the service image store, which is a place in which service images are actually stored, may be divided into a public image storage in which public images are stored and a private image storage in which private images are stored. Furthermore, in the private image storage, users' image storage spaces divided for respective users may be provided.

That is, public images are service images accessible by all users, and may be stored in the public image storage. Further, such public images may be either free images or charged images, the specific prices of which are fixed, depending on the intensions of users who register the images. Furthermore, private images are service images accessible by only users who registered the service images, and may be stored only in the private image storages of corresponding registrants.

Therefore, when each user searches for a service image, a search target may correspond to all service images stored in the public image storage and service images stored in the private image storage of the user who performs a search. Here, values used to search for images may be designated based on the values of basic image information and image execution environment information. For example, the case where a web server service image, which is executed on an OpenStack cloud server and supports a load balancer, and the price of which is below 300 dollars, is searched for may correspond to such a search case.

Here, one or more candidate service images may be recommended based on at least one of a cloud type, service specification, a service type, price, and location that satisfy requirements. For example, candidate service images may be searched for and recommended based on pieces of information corresponding to items related to the selection of candidate service images among pieces of information included in the requirements.

When at least one candidate service image corresponds to a public image, it is determined whether the candidate service image is a charged image, the price of which is fixed, and then purchase information may be provided to the user. For example, when a recommended candidate service image is assumed to be a charged image, a payment button enabling a payment flow to be performed may be provided together with the price of the corresponding charged image.

Further, the cloud service brokerage method using a service image store according to the embodiment of the present invention recommends one or more candidate cloud servers that satisfy the requirements among multiple cloud servers at step S630. That is, the cloud servers capable of executing the one or more candidate service images recommended based on the user's requirements may be recommended.

Here, one or more candidate cloud servers may be recommended based on image execution environment information corresponding to the one or more candidate service images. For example, the information of cloud servers suitable for the arrangement of the corresponding service image may be acquired based on the image execution environment information, and candidate cloud servers may be searched for and recommended using the acquired information.

Further, the cloud service brokerage method using a service image store according to the embodiment of the present invention transmits, to the user, the results of a service implemented by registering and executing an optimal service image selected by the user from among one or more candidate service images, in an optimal cloud server selected by the user from among the one or more candidate cloud servers at step S640. That is, the service requested by the user is executed on the optimal cloud server via the optimal service image and the results of execution are transmitted back to the user, thus enabling the cloud service to be mediated.

In this regard, information about the one or more candidate cloud servers may be provided to the user so that the user may select the optimal cloud server. Further, information about the one or more candidate service images may be provided to the user so that the user may select the optimal service image.

Although not shown in FIG. 6, the cloud service brokerage method using a service image store according to the embodiment of the present invention is configured to, when the user acquires a public image from the service image store, generate a new private image identical to the public image, copy image metadata corresponding to the public image, and generate new image metadata corresponding to the new private image.

Here, the storage operation information of the public image is checked, and a new private image may not be generated when the public image is in use.

For example, if it is assumed that service image A registered in the public image storage is acquired in order for the user to use service image A, it may be determined whether service image A is currently in use, using the image metadata of service image A. The image metadata of service image A is copied to generate new image metadata B only when service image A is not in use, and thereafter the value of image metadata B may be set to ‘in use’. Then, service image A may be copied to the image storage of the private user and then private image B may be generated. Further, after information corresponding to private image B has been registered in generated image metadata B, the values of service image A and private image B, set to ‘in use’, may be released.

Furthermore, although not shown in FIG. 6, the cloud service brokerage method using a service image store according to the embodiment of the present invention is configured to, when the user shares a private image, generate a new public image identical to the private image, copy image metadata corresponding to the private image, and then generate new image metadata corresponding to the new public image.

Here, when the new public image is shared at a charge, price information is recorded in the new image metadata, and the new public image may be set as a charged image.

For example, assuming that a private user shares service image C registered in his or her private image storage with the public image storage, it may be determined whether service image C is currently in use, using the image metadata of service image C. The image metadata of service image C may be copied to generate new image metadata D only when service image C is not in use, and the value of image metadata D may be set to ‘in use’. Thereafter, service image C may be copied to the public image storage, and then public image D may be generated. After information corresponding to public image D has been recorded in generated image metadata D, the values of both service image C and public image D, set to ‘in use’, may be released.

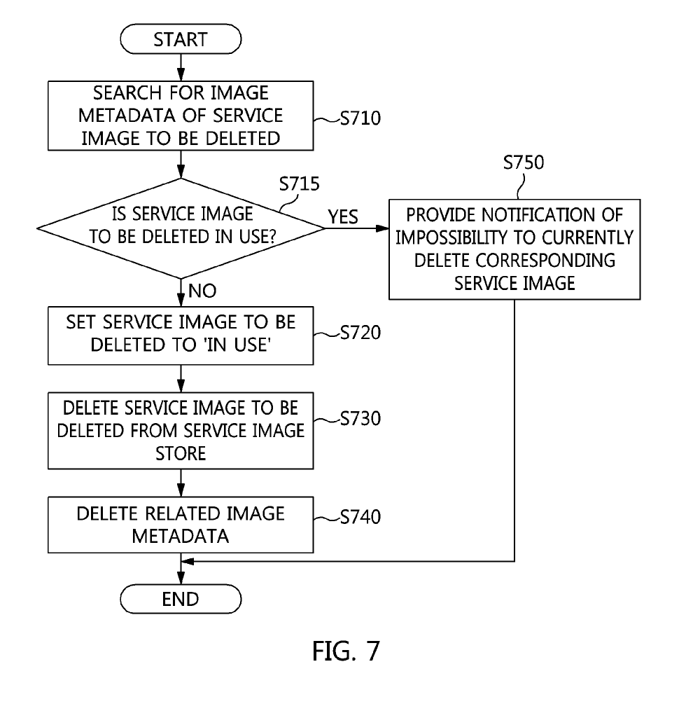

FIG. 7 is an operation flowchart showing a method for deleting a service image from a service image store according to an embodiment of the present invention.

Referring to FIG. 7, the method for deleting a service image from the service image store according to the embodiment of the present invention may first search for the image metadata of a service image to be deleted at step S710.

Thereafter, whether the service image to be deleted is in use may be determined by checking the value of the image metadata at step S715.

If it is determined at step S715 that the service image to be deleted is not in use, the value of the image metadata of the service image to be deleted may be set to ‘in use’ at step S720.

Thereafter, the service image to be deleted is deleted from the service image store at step S730, and image metadata corresponding to the deleted service image may also be deleted at step S740.

In contrast, if it is determined at step S715 that the service image to be deleted is currently in use, it is determined that the deletion of the corresponding image is currently impossible because the image is in use, and notification of such impossibility information may be provided to the user at step S750.

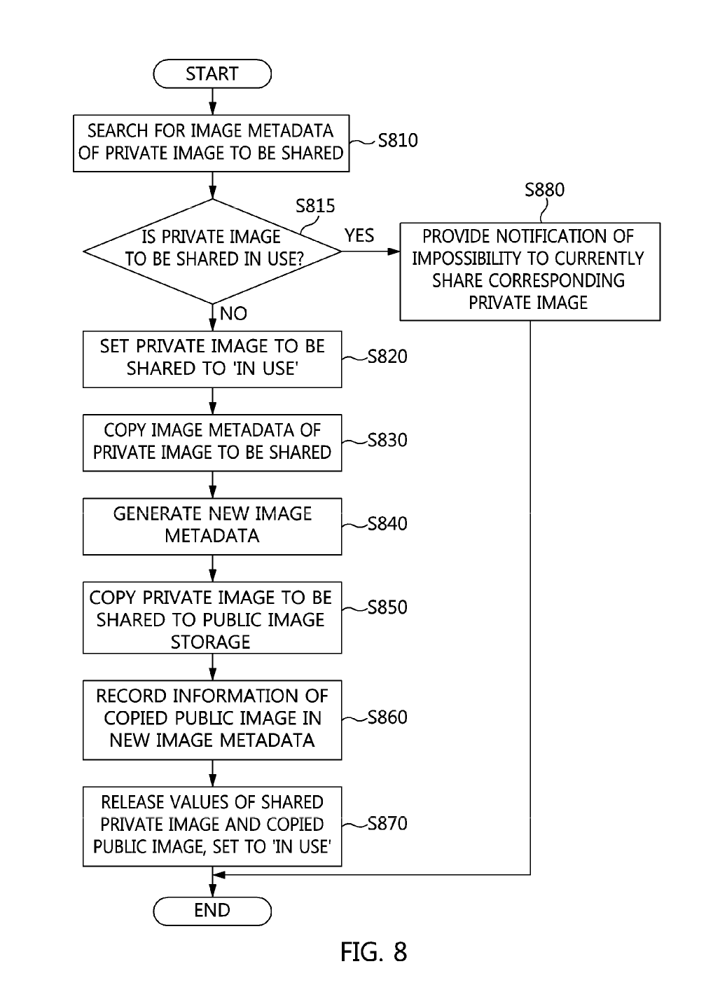

FIG. 8 is an operation flowchart showing a method for sharing a private image in the service image store according to an embodiment of the present invention.

Referring to FIG. 8, the method for sharing a private image in the service image store according to the embodiment of the present invention may search for the image metadata of a private image to be shared at step S810.

Next, whether the private image to be shared is currently in use may be determined by checking the value of the image metadata at step S815.

If it is determined at step S815 that the private image to be shared is not currently in use, the value of the image metadata of the private image to be shared may be set to ‘in use’ at step S820.

Then, the image metadata of the private image to be shared may be copied at step S830, and then new image metadata may be generated at step S840.

Thereafter, the private image to be shared is copied to the public image storage at step S850, and the information of the copied public image may be recorded in the new image metadata at step S860.

Next, the values of the image metadata of both the shared private image and the copied public image, set to ‘in use’, may be released to ‘not in use’.

In contrast, if it is determined at step S815 that the private image to be shared is in use, it is determined that the sharing of the corresponding image is currently impossible because the image is in use, and notification of such impossibility information may be provided to the user at step S880.

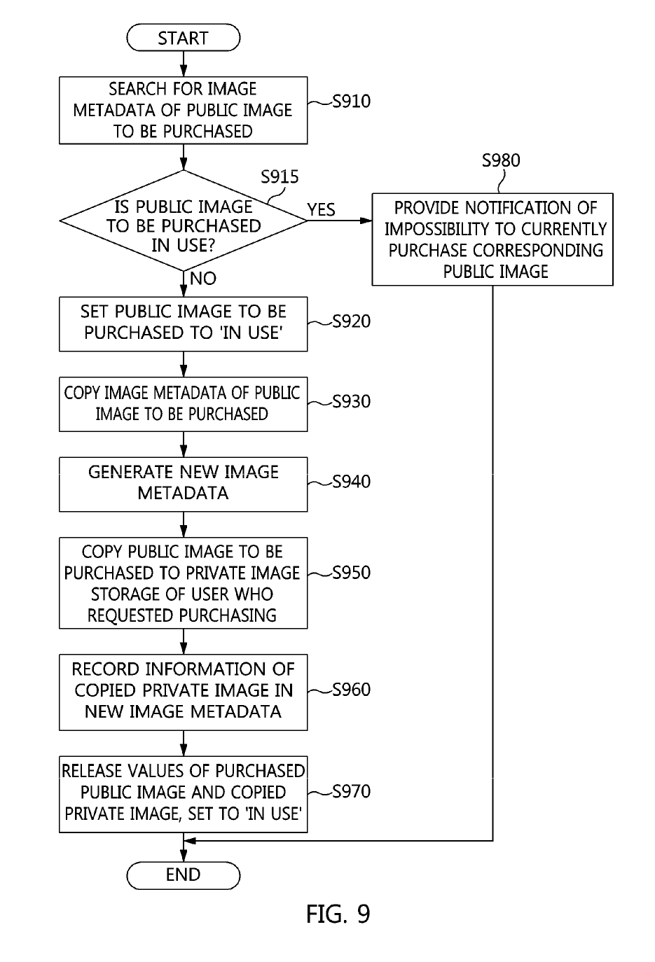

FIG. 9 is an operation flowchart showing a method for purchasing a public image from a service image store according to an embodiment of the present invention.

Referring to FIG. 9, the method for purchasing a public image from the service image store according to the embodiment of the present invention may search for the image metadata of a public image to be purchased at step S910.

Thereafter, whether the public image to be purchased is currently in use may be determined by checking the value of the image metadata at step S915.

If it is determined at step S915 that the public image to be purchased is not currently in use, the value of the image metadata of the public image to be purchased may be set to ‘in use’ at step S920.

Then, the image metadata of the public image to be purchased may be copied at step S930, and then new image metadata may be generated at step S940.

Thereafter, the public image to be purchased is copied to the private image storage of the user who requested the purchasing at step S950, and the information of the copied private image may be recorded in the new image metadata at step S960.

Next, the values of the image metadata of both the purchased public image and the copied private image, set to ‘in use’, may be released to ‘not in use’ at step S970.

In contrast, if it is determined at step S915 that the public image to be purchased is currently in use, it is determined that the purchase of the public image is currently impossible because the image is in use, and notification of such impossibility information may be provided to the user at step S980.

In accordance with the present invention, various cloud services that satisfy user requirements may be provided by mediating a plurality of heterogeneous cloud services that are geographically dispersed.

Further, the present invention may support the prompt deployment of services using a service image store.

Furthermore, the present invention enables open cloud service markets to be activated by removing the complexity of service configuration and setup and supporting the virtuous cycle structure of registration, selling, sharing, and acquisition of service images.

As described above, in the cloud service brokerage method and apparatus using a service image store according to the present invention, the configurations and schemes in the above-described embodiments are not limitedly applied, and some or all of the above embodiments can be selectively combined and configured so that various modifications are possible.

What is claimed is:

1. A cloud service brokerage apparatus using a service image store, comprising:
a reception unit for receiving service requirements from a user;
a service image recommendation unit for recommending one or more candidate service images that satisfy the requirements among multiple service images stored in a service image store;
a cloud server recommendation unit for recommending one or more candidate cloud servers that satisfy the requirements among multiple cloud servers;
a registration unit for registering an optimal service image selected by the user from among the one or more candidate service images in an optimal cloud server selected by the user from among the one or more candidate cloud servers; and
a transmission unit for transmitting results of a service implemented by executing the optimal service image on the optimal cloud server to the user.

2. The cloud service brokerage apparatus of claim 1, wherein the service image recommendation unit recommends the one or more candidate service images using image metadata that includes at least one of basic image information, image execution environment information, and store operation information corresponding to the multiple service images.

3. The cloud service brokerage apparatus of claim 2, wherein the service image store is configured to store the multiple service images so that each of the service images is classified as one of a public image accessible by other users and a private image accessible by only the user, based on ownerships included in the store operation information.

4. The cloud service brokerage apparatus of claim 3, wherein the service image recommendation unit recommends the one or more candidate service images based on at least one of a cloud type, service specification, a service type, a price and a location that satisfy the requirements.

5. The cloud service brokerage apparatus of claim 4, wherein the cloud server recommendation unit recommends the one or more candidate cloud servers based on the image execution environment information corresponding to the one or more candidate service images.

6. The cloud service brokerage apparatus of claim 3, wherein the service image recommendation unit is configured to, when each of the one or more candidate service images corresponds to the public image, determine whether the candidate service image is a charged image, a price of which is fixed, and provide purchase information to the user.

7. The cloud service brokerage apparatus of claim 6, further comprising a service image acquisition unit for, when the user acquires the public image from the service image store, generating a new private image identical to the public image, copying image metadata corresponding to the public image, and generating new image metadata corresponding to the new private image.

8. The cloud service brokerage apparatus of claim 7, wherein the service image acquisition unit checks store operation information of the public image, and generates no new private image when the public image is in use.

9. The cloud service brokerage apparatus of claim 6, further comprising a service image sharing unit for, when the user shares the private image, generating a new public image identical to the private image, copying image metadata corresponding to the private image, and generating new image metadata corresponding to the new public image.

10. The cloud service brokerage apparatus of claim 9, wherein the service image sharing unit is configured to, when the new public image is shared at a charge, record price information in the new image metadata, and set the new public image as a charged image.

11. A cloud service brokerage method using a service image store, comprising:
receiving service requirements from a user;
recommending one or more candidate service images that satisfy the requirements among multiple service images stored in a service image store;
recommending one or more candidate cloud servers that satisfy the requirements among multiple cloud servers; and
transmitting, to the user, results of a service implemented by registering and executing an optimal service image selected by the user from among the one or more candidate service images on an optimal cloud server selected by the user from among the one or more candidate cloud servers.

12. The cloud service brokerage method of claim 11, wherein recommending the one or more candidate service images is configured to recommend the one or more candidate service images using image metadata that includes at least one of basic image information, image execution environment information, and store operation information corresponding to the multiple service images.

13. The cloud service brokerage method of claim 12, wherein the service image store is configured to store the multiple service images so that each of the service images is classified as one of a public image accessible by other users and a private image accessible by only the user, based on ownerships included in the store operation information.

14. The cloud service brokerage method of claim 13, wherein recommending the one or more candidate service images is configured to recommend the one or more candidate service images based on at least one of a cloud type, service specification, a service type, a price and a location that satisfy the requirements.

15. The cloud service brokerage method of claim 14, wherein recommending the one or more candidate cloud servers is configured to recommend the one or more candidate cloud servers based on the image execution environment information corresponding to the one or more candidate service images.

16. The cloud service brokerage method of claim 13, wherein:
recommending the one or more candidate service images comprises, when each of the one or more candidate service images corresponds to the public image, determining whether the candidate service image is a charged image, a price of which is fixed,
if it is determined that the candidate service image is the charged image, purchase information is provided to the user.

17. The cloud service brokerage method of claim 16, further comprising:
when the user acquires the public image from the service image store, generating a new private image identical to the public image, copying image metadata corresponding to the public image, and generating new image metadata corresponding to the new private image.

18. The cloud service brokerage method of claim 17, wherein generating the new private image is configured to check store operation information of the public image and generate no new private image when the public image is in use.

19. The cloud service brokerage method of claim 16, further comprising:
when the user shares the private image, generating a new public image identical to the private image, copying image metadata corresponding to the private image, and generating new image metadata corresponding to the new public image.

20. The cloud service brokerage method of claim 19, wherein generating the new image metadata is configured to, when the new public image is shared at a charge, record price information in the new image metadata, and set the new public image as a charged image.
